(19) United States
(12) Patent Application Publication
(10) Pub. No.: US 2017/0069117 A1
(43) Pub. Date: Mar. 9, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventors: Yohei YAMANE, Kanagawa (JP); Masao WATANABE, Kanagawa (JP)

(73) Assignee: FUJI XEROX CO., LTD., Tokyo (JP)

(21) Appl. No.: 15/050,814

(22) Filed: Feb. 23, 2016

(30) Foreign Application Priority Data
Sep. 3, 2015 (JP) 2015-173452

(51) Int. Cl. G06T 11/20; G06F 3/0484

(52) U.S. Cl. CPC G06T 11/206; G06F 3/04847

(57) ABSTRACT

An information processing apparatus includes a first presenting unit, a second presenting unit, a receiving unit, and a controller. The first presenting unit presents first information in a chronological order in a first region. The second presenting unit presents hierarchized second information which is associated with the first information in a second region. The receiving unit receives specification of a layer of the second information. The controller controls the second presenting unit such that the second information in the specified layer is presented in the second region, and controls the first presenting unit such that first information which is associated with the second information is presented in the first region.

### CROSS-REFERENCE TO RELATED APPLICATIONS

This application is based on and claims priority under 35 USC 119 from Japanese Patent Application No. 2015-173452 filed Sep. 3, 2015.

### BACKGROUND

### Technical Field

The present invention relates to an information processing apparatus, an information processing method, and a non-transitory computer readable medium.

### SUMMARY

According to an aspect of the invention, there is provided an information processing apparatus including a first presenting unit, a second presenting unit, a receiving unit, and a controller. The first presenting unit presents first information in a chronological order in a first region. The second presenting unit presents hierarchized second information which is associated with the first information in a second region. The receiving unit receives specification of a layer of the second information. The controller controls the second presenting unit such that the second information in the specified layer is presented in the second region, and controls the first presenting unit such that first information which is associated with the second information is presented in the first region.

### BRIEF DESCRIPTION OF THE DRAWINGS

Exemplary embodiments of the present invention will be described in detail based on the following figures, wherein:

FIG. 1 is a conceptual module configuration diagram of a configuration example according to an exemplary embodiment;

FIG. 2 is an explanatory diagram illustrating an example of a system configuration according to an exemplary embodiment;

FIG. 3 is a flowchart illustrating a processing example according to an exemplary embodiment;

FIG. 4 is an explanatory diagram illustrating an example of a data structure of an event information table;

FIG. 5 is an explanatory diagram illustrating an example of a data structure of a module configuration;

FIG. 6 is an explanatory diagram illustrating an example of a data structure of a module table;

FIG. 7 is an explanatory diagram illustrating an example of a data structure of an event-module correspondence table;

FIG. 8 is an explanatory diagram illustrating an example of a data structure of a task table;

FIG. 9 is an explanatory diagram illustrating an example of a data structure of an event-task correspondence table;

FIG. 10 is an explanatory diagram illustrating an example of a data structure of organizational structure information;

FIG. 11 is an explanatory diagram illustrating an example of a data structure of a person name table;

FIG. 12 is an explanatory diagram illustrating an example of a data structure of an event-person correspondence table;

FIG. 13 is an explanatory diagram illustrating a presentation example according to an exemplary embodiment;

FIG. 14 is an explanatory diagram illustrating a presentation example according to an exemplary embodiment;

FIG. 15 is an explanatory diagram illustrating a presentation example according to an exemplary embodiment;

FIG. 16 is an explanatory diagram illustrating a presentation example according to an exemplary embodiment;

FIG. 17 is an explanatory diagram illustrating a presentation example according to an exemplary embodiment;

FIG. 18 is an explanatory diagram illustrating a presentation example according to an exemplary embodiment;

FIG. 19 is an explanatory diagram illustrating a presentation example according to an exemplary embodiment;

FIG. 20 is an explanatory diagram illustrating a presentation example according to an exemplary embodiment; and

FIG. 21 is a block diagram illustrating an example of a hardware configuration of a computer according to an exemplary embodiment.

### DETAILED DESCRIPTION

Hereinafter, exemplary embodiments of the present invention will be described with reference to the drawings.

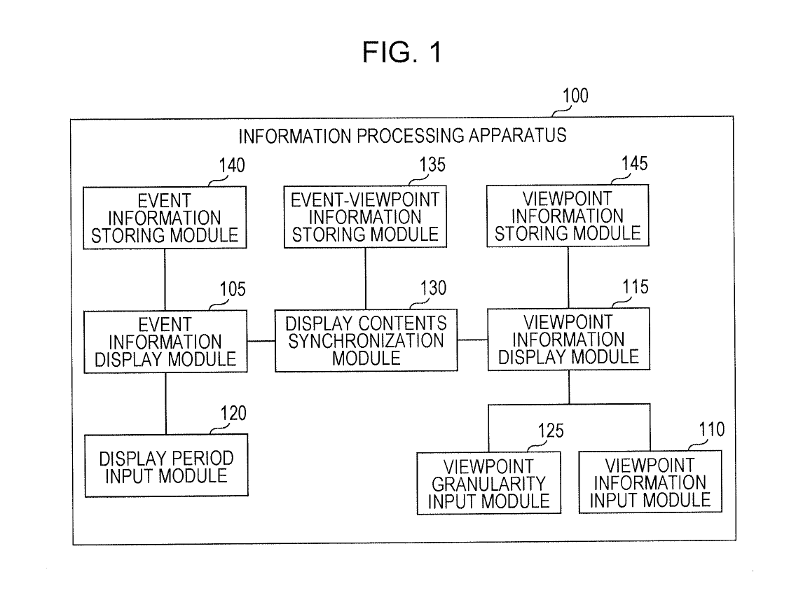

FIG. 1 is a conceptual module configuration diagram of a configuration example according to an exemplary embodiment.

In general, the term “module” refers to a component such as software (a computer program), hardware, or the like, which may be logically separated. Therefore, a module in an exemplary embodiment refers not only to a module in a computer program but also to a module in a hardware configuration. Accordingly, through an exemplary embodiment, a computer program for causing the component to function as a module (a program for causing a computer to perform each step, a program for causing a computer to function as each unit, and a program for causing a computer to perform each function), a system, and a method are described. However, for convenience of description, the terms “store”, “cause something to store”, and other equivalent expressions will be used. When an exemplary embodiment relates to a computer program, the terms and expressions represent “causing a storage device to store”, or “controlling a storage device to store”. A module and a function may be associated on a one-to-one basis. In the actual implementation, however, one module may be implemented by one program, multiple modules may be implemented by one program, or one module may be implemented by multiple programs. Furthermore, multiple modules may be executed by one computer, or one module may be executed by multiple computers in a distributed computer environment or a parallel computer environment. Moreover, a module may include another module. In addition, hereinafter, the term “connection” may refer to logical connection (such as data transfer, instruction, and cross-reference relationship between data) as well as physical connection. The term “being predetermined” represents being set prior to target processing being performed. “Being predetermined” represents not only being set prior to processing in an exemplary embodiment but also being set even after the processing in the exemplary embodiment has started, in accordance with the condition and state at that time or in accordance with the condition and state during a period up to that time, as long as being set prior to the target processing being performed. When there are plural “predetermined values”, the values may be different from one another, or two or more values (obviously, including all the values) may be the same. The term “in the case of A, B is performed” represents “a determination as to whether it is A or not is performed, and when it is determined to be A, B is performed”, unless the determination of whether it is A or not is not required.

Moreover, a “system” or an “apparatus” may be implemented not only by multiple computers, hardware, devices, or the like connected through a communication unit such as a network (including a one-to-one communication connection), but also by a single computer, hardware, apparatus, or the like. The terms “apparatus” and “system” are used as synonymous terms. Obviously, the term “system” does not include social “mechanisms” (social system), which are only artificially arranged.

Furthermore, for each process in a module or for individual processes in a module performing plural processes, target information is read from a storage device and a processing result is written to the storage device after the process is performed. Therefore, the description of reading from the storage device before the process is performed or the description of writing to the storage device after the process is performed may be omitted. The storage device may be a hard disk, a random access memory (RAM), an external storage medium, a storage device using a communication line, a register within a central processing unit (CPU), or the like.

An information processing apparatus 100 according to an exemplary embodiment presents information. As illustrated in an example of FIG. 1, the information processing apparatus 100 includes an event information display module 105, a viewpoint information input module 110, a viewpoint information display module 115, a display period input module 120, a viewpoint granularity input module 125, a display contents synchronization module 130, an event-viewpoint information storing module 135, an event information storing module 140, and a viewpoint information storing module 145.

The information processing apparatus 100 is used for processing of presenting information, such as, for example, a design operation. Application examples in design operations will be described below.

In a design operation, a designer considers an assumed problem in advance, and carries out designing in accordance with a requirement.

However, in accordance with commonality of parts and modules, the range affected by a design change of a single part has increased, and the influence exerted at occurrence of a failure has also increased.

Furthermore, in recent years, consideration including procurement, production, and distribution has been required, and a wider range has needed to be considered.

Moreover, due to a reduction in the life of products, the period between designing and introduction to market has been shortened, and decision making including designing has been required to be performed quickly.

In order to handle such a situation, an approach called product life cycle management (PLM) has been proposed. PLM is an approach for comprehensively managing products through all the process of a planning stage for development of industrial products, designing, production, and user support after shipment in that order.

Software for implementing PLM is a PLM system. The PLM system is a system for managing the entire life cycle of a product in an integrated manner, and is able to handle information such as a parts list, a diagram, a workflow, a document life cycle, and the like.

An object of the PLM system is to manage information which belongs to multiple divisions in an integrated manner so that decision making may be done quickly.

In a design operation, there is a demand for tracking a discussion in order to understand a reason for a design change or the like.

For example, to review a reason why such a change has been made, information of a recent meeting and email will be referred to. However, by learning who and when a corresponding activity was done, a query may be made to the person who was involved in the activity.

Furthermore, for derived development, there is a demand for understanding a process of the last development.

The information processing apparatus 100 provides, for example, a function of displaying content information (a document, a diagram, an email, a sound, a moving image, and the like) and event information (a conference, a task, a change request, and the like) which are managed over multiple systems in a chronological order and a function of displaying the content information and the event information in a viewpoint which is specified by a user. The content information and the event information correspond to information having a hierarchical structure.

The information processing apparatus 100 changes a display target for content information and event information by changing either of the range to be displayed in a chronological order or the viewpoint granularity, and therefore allows review of past activities.

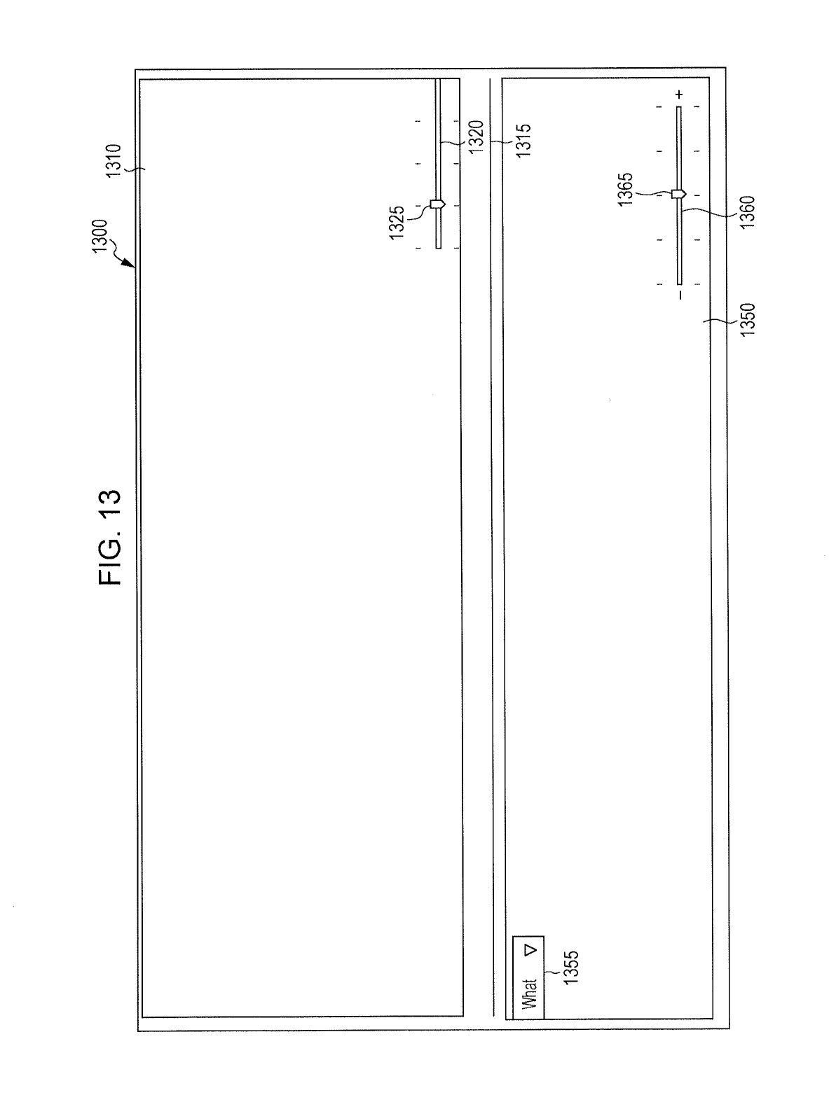

The event information display module 105 is connected to the display period input module 120, the display contents synchronization module 130, and the event information storing module 140. The event information display module 105 presents first information in a chronological order in a first region. For example, the event information display module 105 displays event information or content information (hereinafter, event information will be used as an example) in a chronological order on a display such as a liquid crystal display. “Presentation” may include display on a display (including a three-dimensional display), output of sound to a sound output device such as a speaker, vibration, and a combination of the above. The same applies to presentation at the viewpoint information display module 115. Furthermore, the first region may be any region as long as it is different from a second region. As described later with reference to an example of FIG. 13, an upper portion and a lower portion of a screen may be defined as the first region and the second region, respectively. However, the upper portion and the lower portion may be defined as the second region and the first region, respectively. The first and second regions may be located in left and right portions. One and the other of two displays may be defined as the first and second regions.

The viewpoint information input module 110 is connected to the viewpoint information display module 115 and the viewpoint granularity input module 125. The viewpoint information input module 110 receives a viewpoint in hierarchization of second information. For example, the viewpoint information input module 110 provides a function of allowing a user to input a viewpoint with which the user wants to browse.

The viewpoint information display module 115 is connected to the viewpoint information input module 110, the viewpoint granularity input module 125, the display contents synchronization module 130, and the viewpoint information storing module 145. The viewpoint information display module 115 presents hierarchized information regarding the first information in the second region. For example, the viewpoint information display module 115 displays in a chronological order information of a viewpoint input by a user through the viewpoint information input module 110.

The display period input module 120 is connected to the event information display module 105. The display period input module 120 receives a target period of the first information to be displayed in the first region. For example, the display period input module 120 provides a function of allowing a user to input a period of event information to be displayed. That is, the display period input module 120 allows the time scale of a time axis to be changed in a desired manner in accordance with a user operation.

The viewpoint granularity input module 125 is connected to the viewpoint information input module 110 and the viewpoint information display module 115. The viewpoint granularity input module 125 receives specification of a layer of the second information. For example, the viewpoint granularity input module 125 provides a function of allowing a user to input the granularity of information of a viewpoint to be displayed.

The display contents synchronization module 130 is connected to the event information display module 105, the viewpoint information display module 115, and the event-viewpoint information storing module 135. The display contents synchronization module 130 controls the viewpoint information display module 115 such that the second information in the layer specified by input through the viewpoint information input module 110 is presented in the second region, and controls the event information display module 105 such that the first information which is associated with the second information is presented in the first region.

Furthermore, the display contents synchronization module 130 may control the event information display module 105 such that the first information within the target period input through the display period input module 120 is presented in the first region, and may control the viewpoint information display module 115 such that the second information which is associated with the first information is presented in the second region in association with the first information within the first region.

Furthermore, the display contents synchronization module 130 may perform control such that the second information which is in a layer upper than the layer specified by input through the viewpoint granularity input module 125 is presented in the second region.

Furthermore, when the second information in the layer specified by input through the viewpoint granularity input module 125 is not associated with the first information presented in the first region, the display contents synchronization module 130 may perform control such that the second information is not presented in the second region. For example, if content information or event information which corresponds to information of a viewpoint corresponding to the layer specified by input through the viewpoint granularity input module 125 is not displayed, the information of the viewpoint is not to be displayed.

Furthermore, the display contents synchronization module 130 may control the viewpoint information display module 115 such that the second information regarding a viewpoint input through the viewpoint information input module 110 which is specified by input through the viewpoint granularity input module 125 is presented in the second region, and may control the event information display module 105 such that the first information which is associated with the second information is presented in the first region.

For example, based on the period input through the display period input module 120 and the granularity input through the viewpoint granularity input module 125, information to be displayed at the event information display module 105 and the viewpoint information display module 115 is determined.

The event-viewpoint information storing module 135 is connected to the display contents synchronization module 130. The event-viewpoint information storing module 135 stores information which associates the first information with the second information. For example, the event-viewpoint information storing module 135 stores information which links (associates) event information with a viewpoint.

The event information storing module 140 is connected to the event information display module 105. The event information storing module 140 stores the first information. For example, the event information storing module 140 stores event information.

The viewpoint information storing module 145 is connected to the viewpoint information display module 115. The viewpoint information storing module 145 stores the second information. For example, the viewpoint information storing module 145 stores information which indicates a viewpoint for each viewpoint (for example, “object (what)”, “thing (how)”, and “person (who)”).

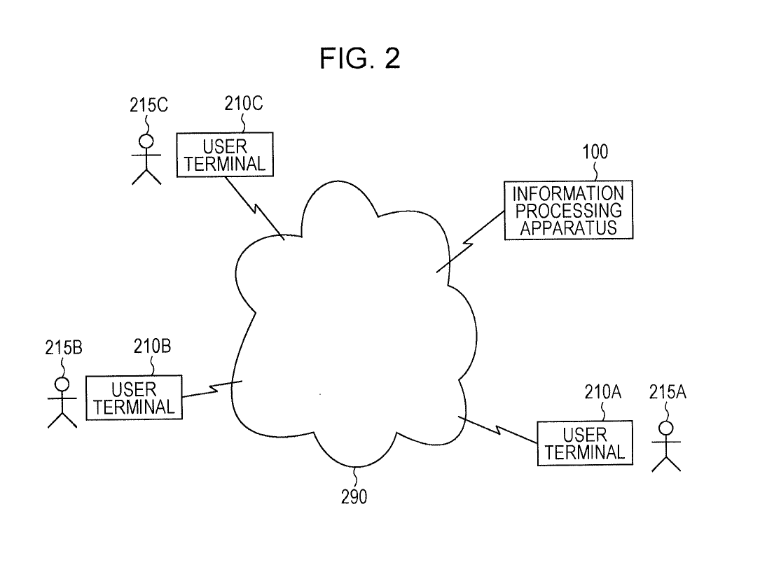

The information processing apparatus 100 may be caused to function as a stand-alone apparatus or a server, as illustrated in an example of FIG. 2.

FIG. 2 is an explanatory diagram illustrating an example of a system configuration according to an exemplary embodiment.

The information processing apparatus 100, a user terminal 210A, a user terminal 210B, and a user terminal 210C are connected to one another through a communication line 290. The communication line 290 may be a wireless line, a wired line, or a combination of wireless and wired lines. The communication line 290 may be, for example, the Internet, an intranet, or the like as a communication infrastructure. Furthermore, functions of the image processing apparatus 100 may be implemented as cloud service. The user terminals 210 have, for example, a browser function for communicating with the information processing apparatus 100.

The display period input module 120, the viewpoint granularity input module 125, and the viewpoint information input module 110 of the information processing apparatus 100 receive an operation of a user 215 through the user terminals 210. The event information display module 105 and the viewpoint information display module 115 of the information processing apparatus 100 perform display on a display of the user terminals 210 in accordance with the operation.

For example, as described above, the user 215 is a person who performs a design operation and issues an instruction for searching for a process such as designing until the current time and information of past related designing. As a search result, event information and hierarchized information from the information processing apparatus 100 are displayed in association with each other on the user terminals 210.

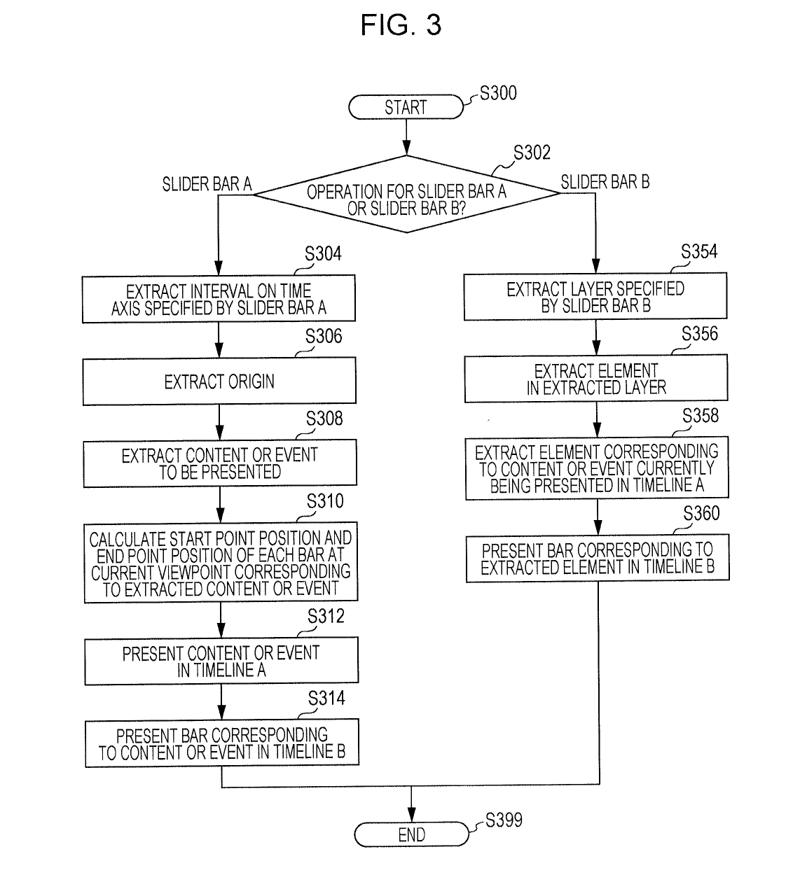

FIG. 3 is a flowchart illustrating a processing example according to an exemplary embodiment.

In step S302, it is determined whether an operation has been performed for a slider bar A (the display period input module 120) or a slider bar B (the viewpoint granularity input module 125). When an operation has been performed for the slider bar A, the process proceeds to step S304. When an operation has been performed for the slider bar B, the process proceeds to step S354. The slider bar A is provided for adjusting the time scale of a display target for the first region. The slider bar B is provided for adjusting the layer of a display target for the second region. In general, the slider bar A is displayed within the first region, and the slider bar B is displayed within the second region.

In step S304, the interval of the time axis specified by the slider bar A is extracted. Specifically, a time length corresponding to a unit length in the first region is calculated.

In step S306, the origin is extracted. The origin indicates the starting point in the time scale adjusted by the slider bar A in step S302 in the first region. For example, as the origin, any of the dates and times corresponding to the left end, the center, and the right end of the first region (may be year, month, date, hours, minutes, seconds, a unit smaller than seconds, or a combination of some of them) is fixed, and the time axis is adjusted.

In step S308, content information or event information to be presented in the first region is extracted. That is, content information or event information corresponding to the time interval within the first region is extracted from the event information storing module 140.

In step S310, the start point position and the end point position of each bar at the current viewpoint corresponding to the extracted content information or event information are calculated. That is, the length and the display position of a bar indicating viewpoint information displayed in the second region is calculated. The temporally first and last layers of the viewpoint corresponding to the content information or the event information displayed in the first region are extracted. The display position of a bar in the second region is determined in accordance with the display position in the first region.

In step S312, the content information or the event information is presented in the timeline A, which is the first region.

In step S314, a bar corresponding to the content information or the event information is presented in the timeline B, which is the second region.

In step S354, the layer specified by the slider bar B is extracted. Specifically, in the hierarchical structure at the current viewpoint, a layer to be displayed by specification through the slider bar B is extracted.

In step S356, an element in the extracted layer (corresponding to the bar displayed in the timeline B) is extracted.

In step S358, an element corresponding to the content information or the event information currently being presented in the timeline A is extracted.

In step S360, a bar corresponding to the extracted element is displayed in the timeline B.

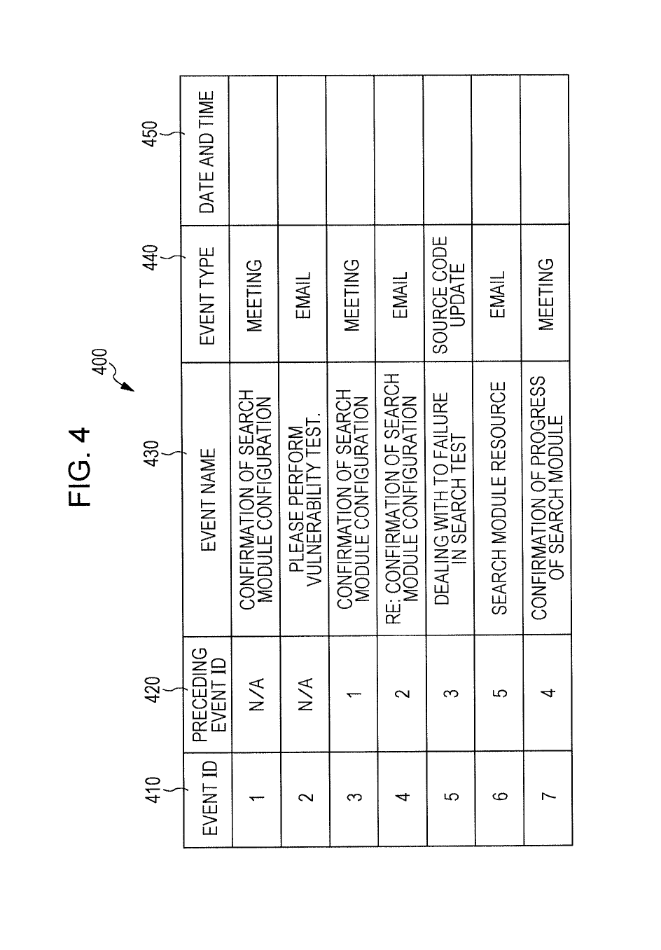

FIG. 4 is an explanatory diagram illustrating an example of a data structure of an event information table 400. The event information table 400 is stored in the event information storing module 140.

The event information table 400 includes an event identification (ID) field 410, a preceding event ID field 420, an event name field 430, an event type field 440, and a date and time field 450. The event ID field 410 stores information (event ID) for uniquely identifying event information in an exemplary embodiment. The preceding event ID field 420 stores an event ID of event information that precedes the event information. The information indicates the relationship between event information. If there is no preceding event, “N/A” is stored. The event name field 430 stores the name of the event information (for example, the name of the event such as the name of a conference and the title of an email). The event type field 440 stores the type of the event. In this example, for simplification, any one of “meeting”, “email”, and “source code update” is used. However, other event types may be added as necessary. The date and time field 450 stores the date and time at which the event occurred, or the like. The date and time is used for determining the display position in the timeline A.

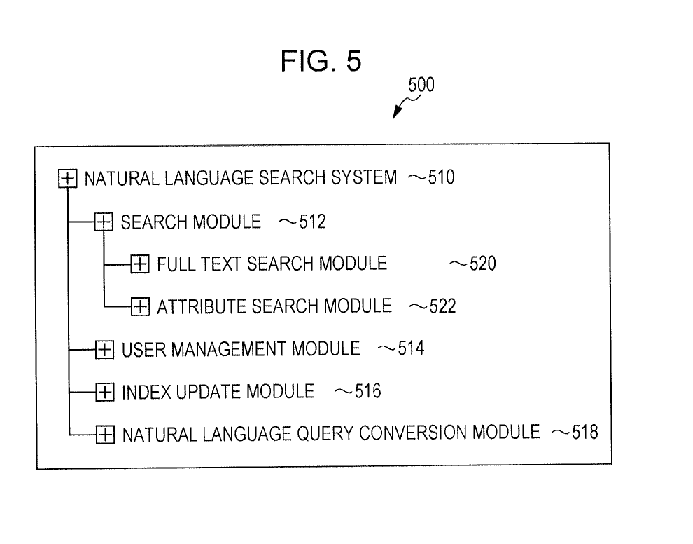

FIG. 5 is an explanatory diagram illustrating an example of a data structure of a module configuration 500. The module configuration 500 is information displayed in the timeline B. A module is one of viewpoints and has a three-layer hierarchical structure.

As the hierarchical structure of the module configuration 500, a natural language search system 510 is defined as a root (highest layer), a search module 512, a user management module 514, an index update module 516, and a natural language query conversion module 518 are arranged below the natural language search system 510, and a full text search module 520 and an attribute search module 522 are arranged below the search module 512. When the first layer is a display target, the natural language search system 510 is displayed. When the second layer is a display target, the search module 512, the user management module 514, the index update module 516, and the natural language query conversion module 518 are displayed. When the third layer is a display target, the full text search module 520 and the attribute search module 522 are displayed.

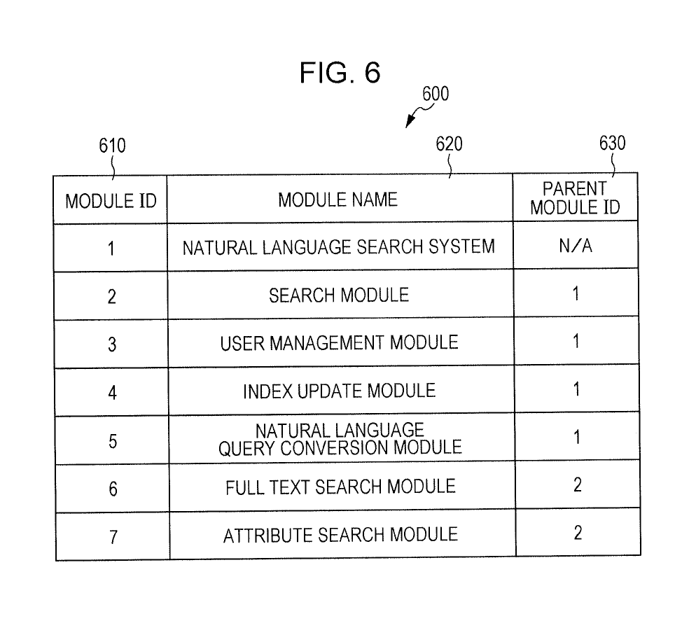

FIG. 6 is an explanatory diagram illustrating an example of a data structure of a module table 600. The module table 600 is stored in the viewpoint information storing module 145. The module table 600 is indicated as a table structure of the module configuration 500 illustrated in the example of FIG. 5.

The module table 600 includes a module ID field 610, a module name field 620, and a parent module ID field 630. The module ID field 610 stores information (module ID) for uniquely identifying a module in an exemplary embodiment. The module name field 620 stores the name of the module. The parent module ID field 630 stores a parent module ID of the module. For example, module IDs 2, 3, 4, and 5 correspond to the search module 512, the user management module 514, the index update module 516, and the natural language query conversion module 518, respectively, in the second layer, an a module ID 1, which is a parent in the hierarchical structure, corresponds to the natural language search system 510 in the first layer.

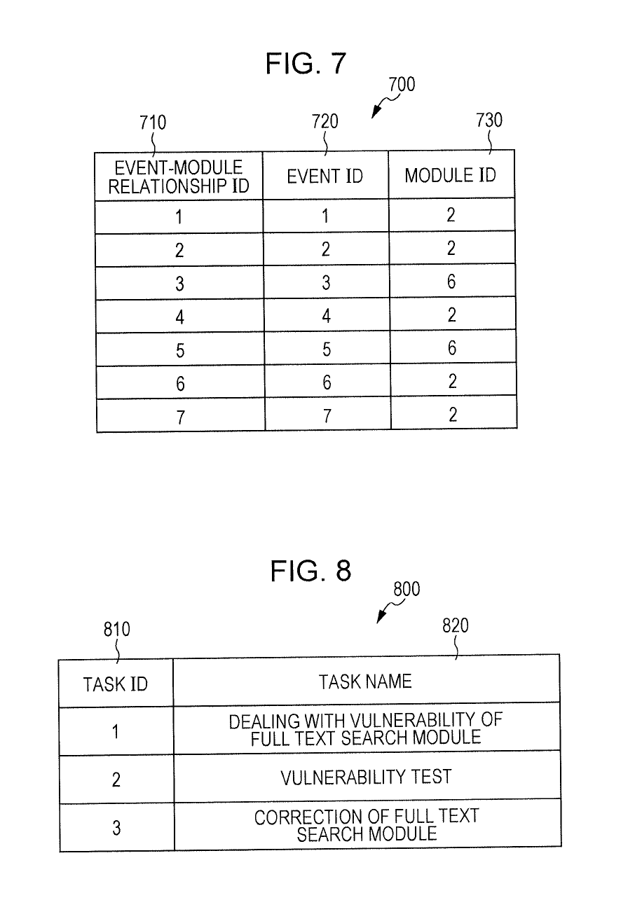

FIG. 7 is an explanatory diagram illustrating an example of a data structure of an event-module correspondence table 700. The event-module correspondence table 700 is stored in the event-viewpoint information storing module 135.

The event-module correspondence table 700 stores the relationship between event information and a module. The event-module correspondence table 700 includes an event-module relationship ID field 710, an event ID field 720, and a module ID field 730. The event-module relationship ID field 710 stores information (event-module-relationship ID) for uniquely identifying the relationship between event information and a module to which the event information belongs (event-module relationship) in an exemplary embodiment. The event ID field 720 stores an event ID. The module ID field 730 stores the module ID of a module to which the event belongs.

FIG. 8 is an explanatory diagram illustrating an example of a data structure of a task table 800. The task table 800 is stored in the viewpoint information storing module 145. The task table 800 is information displayed in the timeline B. A task is one of viewpoints and has a one-layer hierarchical structure.

The task table 800 includes a task ID field 810 and a task name field 820. The task ID field 810 stores information (task ID) for uniquely identifying a task in an exemplary embodiment. The task name field 820 stores the name of the task.

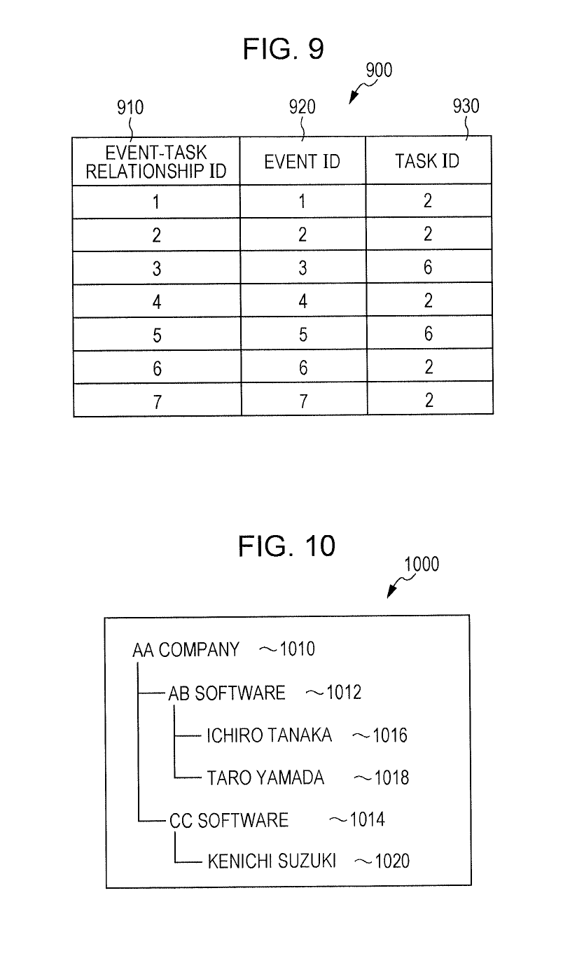

FIG. 9 is an explanatory diagram illustrating an example of a data structure of an event-task correspondence table 900. The event-task correspondence table 900 is stored in the event-viewpoint information storing module 135.

The event-task correspondence table 900 stores the relationship between event information and a task. The event-task correspondence table 900 includes an event-task relationship ID field 910, an event ID field 920, and a task ID field 930. The event-task relationship ID field 910 stores information (event-task relationship ID) for uniquely identifying the relationship between event information and a task to which the event information belongs (event-task relationship) in an exemplary embodiment. The event ID field 920 stores an event ID. The task ID field 930 stores the task ID of a task to which the event information belongs.

FIG. 10 is an explanatory diagram illustrating an example of a data structure of organizational structure information 1000. The organizational structure information 1000 is information displayed in the timeline B. A “person” is one of viewpoints and has a three-layer hierarchical structure.

As the hierarchical structure of the organizational structure information 1000, a company 1010 is defined as a root, AB software 1012 and CC software 1014 are arranged below the company 1010, Ichiro Tanaka 1016 and Taro Yamada 1018 are arranged below the AB software 1012, and Kenichi Suzuki 1020 is arranged below the CC software 1014. When the first layer is a display target, the company 1010 is displayed. When the second layer is a display target, the AB software 1012 and the CC software 1014 are displayed. When the third layer is a display target, Ichiro Tanaka 1016, Taro Yamada 1018, and Kenichi Suzuki 1020 are displayed.

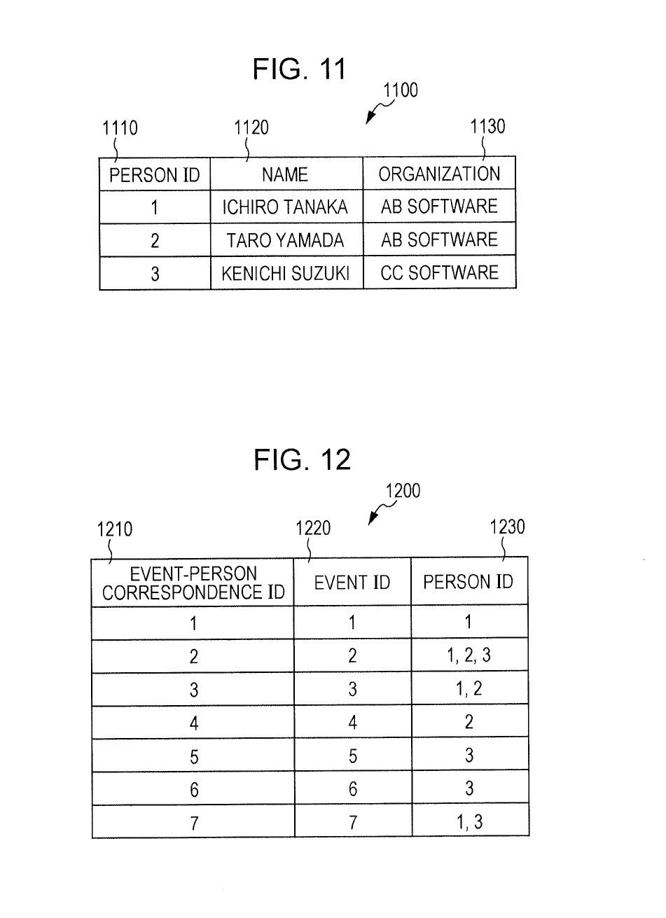

FIG. 11 is an explanatory diagram illustrating an example of a data structure of a person name table 1100. The person name table 1100 is stored in the viewpoint information storing module 145. The person name table 1100 is indicated as a table structure of the organizational structure information 1000 illustrated in the example of FIG. 10. However, the relationship between the first layer and the second layer is omitted.

The person name table 1100 includes a person ID field 1110, a name field 1120, and an organization field 1130. The person ID field 1110 stores information (person ID) for uniquely identifying a “person” in an exemplary embodiment. The name field 1120 stores the name of the person. The organization field 1130 stores the name of an organization to which the person belongs. “Organization” and “person” have a hierarchical relationship. In this example, “organization” and “person” are in a single layer. However, “organization” and “person” may be in two or more layers. Furthermore, an element in the lowest layer may be an organization but not a person.

FIG. 12 is an explanatory diagram illustrating an example of a data structure of an event-person correspondence table 1200. The event-person correspondence table 1200 is stored in the event-viewpoint information storing module 135.

The event-person correspondence table 1200 stores the relationship between event information and a “person” (a list of people who are involved in an event). The event-person correspondence table 1200 includes an event-person correspondence ID field 1210, an event ID field 1220, and a person ID field 1230. The event-person correspondence ID field 1210 stores information (event-person correspondence ID) for uniquely identifying the correspondence between event information and a “person” (event-person correspondence ID) in an exemplary embodiment. The event ID field 1220 stores an event ID. The person ID field 1230 stores a person ID of a “person” who is involved in an event of the event information. A person who is involved in an event may be a “host”, a “participant”, or the like for a “conference”, may be a “sender”, a “recipient”, or the like for an “email”, and may be a “committer” or the like for “source code update”. The definition of an involved person may be added, deleted, or changed as necessary.

FIG. 13 is an explanatory diagram illustrating a presentation example according to an exemplary embodiment. An event or other data presentation screen 1300 is displayed on a display of the user terminal 210.

On the event or other data presentation screen 1300, a timeline A region 1310 which corresponds to the first region and a timeline B region 1350 which corresponds to the second region are displayed, a slider bar A 1320 is displayed within the timeline A region 1310, a time axis 1315 is displayed between the timeline A region 1310 and the timeline B region 1350, and a viewpoint selection pulldown menu 1355 and a slider bar B 1360 are displayed within the timeline B region 1350. The example of FIG. 13 illustrates an initial screen of the event or other data presentation screen 1300. With the slider bar A 1320 and the slider bar B 1360, adjustment of a time scale and specification of a layer are performed by changing the positions of a knob 1325 and a knob 1365 in accordance with a user operation.

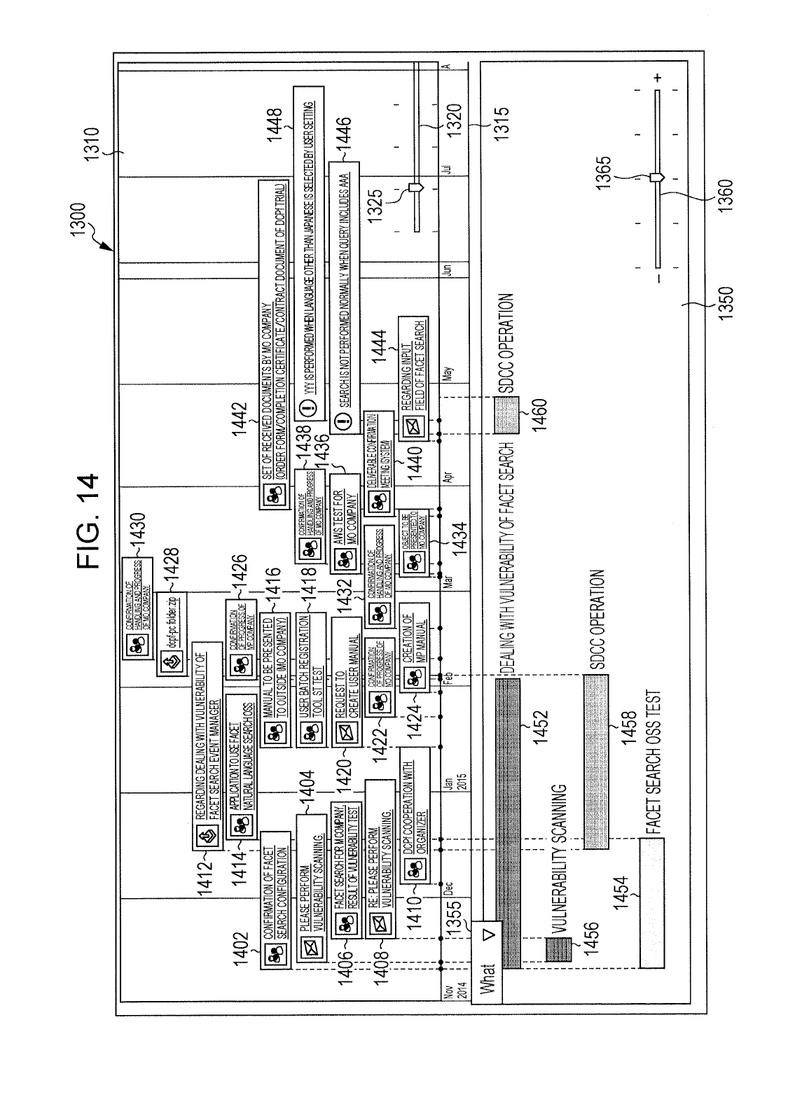

FIG. 14 is an explanatory diagram illustrating a presentation example according to an exemplary embodiment. FIG. 14 illustrates an example in which information is displayed in the timeline A region 1310 and the timeline B region 1350 of the event or other data presentation screen 1300.

In the timeline A region 1310, which is an upper region, event information (event or other information 1402 to 1448) including a conference and document creation/updating and transmission and reception of an email in a chronological order.

Events may be displayed in a non-overlapping manner. If a display space is limited, events may be displayed in an overlapping manner and overlapping events may be separately displayed when mouse over is done on the overlapping events (a mouse cursor is placed over the overlapping events).

In the timeline B region 1350, which is a lower region, elements of a viewpoint (viewpoint element bars 1452 to 1460) selected by a user are displayed in a chronological order. Selection of a viewpoint is performed using the viewpoint selection pulldown menu 1355. In this example, a user is able to select three types of viewpoint: “What”, “How”, and “Who”. However, a user may be able to select one or two types of viewpoint or other viewpoints may be added.

When “What” is selected, an object which is discussed or talked about for an event is displayed in the timeline B region 1350. The object mentioned here indicates a product, a part, a module, a service, or the like. However, other items may be added.

When “How” is selected, a task, a sub-task, or the like to which an event belongs is displayed in the timeline B region 1350.

When “Who” is selected, a participant, an involved person, a host, a sender, a recipient, or the like of an event is displayed in the timeline B region 1350.

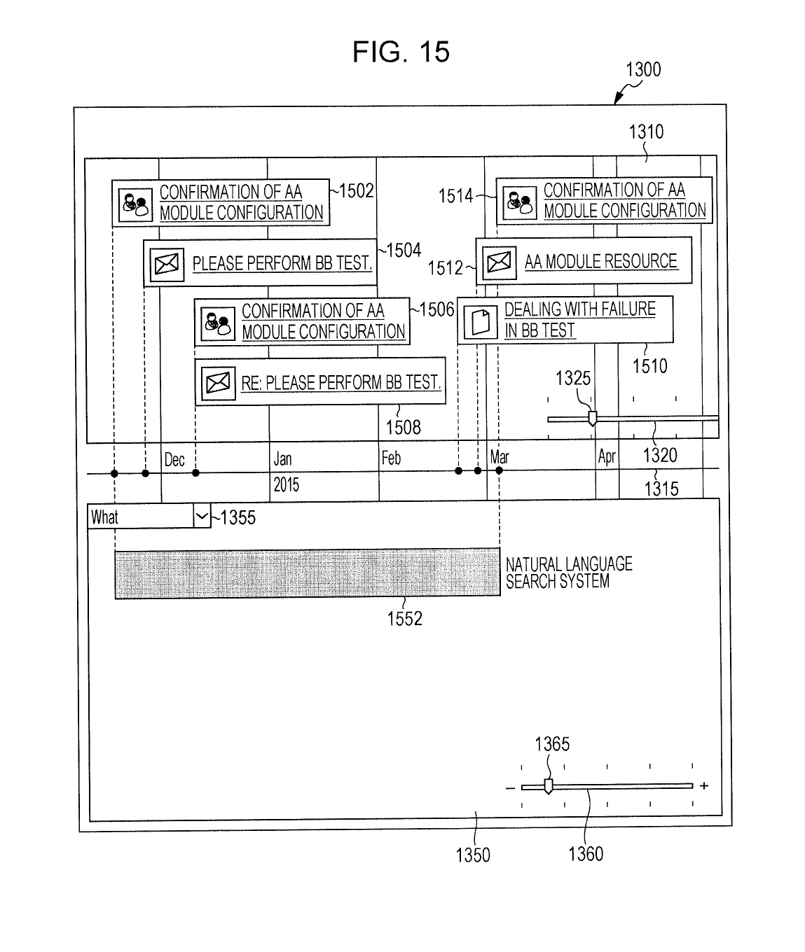

An operation example for the case where a user selects a viewpoint “What” (“What” with the viewpoint selection pulldown menu 1355) will be described below with reference to examples illustrated in FIGS. 15 to 17. Furthermore, the data illustrated in the examples of FIGS. 4 to 6 will be used as target data. The event information table 400 illustrated in the example of FIG. 4 will be used as target event information. A configuration example of target modules is illustrated in FIG. 5. In the example of FIG. 6, the module configuration example illustrated in FIG. 5 is expressed in a table format.

FIG. 15 illustrates a display example for the case where a viewpoint “What” is selected. A viewpoint element bar 1552 indicates a “natural language search system”. Event or other information 1502 to 1514 indicates association with the “natural language search system”. In the example of FIG. 15, the viewpoint element bar 1552 indicating the natural language search system 510, which is the highest module, is displayed in the timeline B region 1350, and all the event information which is associated with the natural language search system 510 (the event or other information 1502 to 1514) is displayed in the timeline A region 1310. By horizontally moving the knob 1365 of the slider bar B 1360 within the timeline B region 1350, the layer of a module to be displayed is changed. In this example, by shifting the knob 1365 of the slider bar B 1360 rightwards, a lower layer is displayed. In contrast, by shifting the knob 1365 of the slider bar B 1360 leftwards, a higher layer is displayed. In order to clarify the date and time at which the event or other information 1502 or the like is generated, a line is drawn from the event or other information 1502 or the like to the time axis 1315, and a line indicating the start point of the viewpoint element bar 1552 (date and time at which the event or other information is generated) and the end point of the viewpoint element bar 1552 (date and time at which the event or other information 1514 is generated) is drawn to the time axis 1315.

If the knob 1325 of the slider bar A 1320 within the timeline A region 1310 is horizontally shifted, the interval between two pieces of information (for example, the interval between the event or other information 1502 and the event or other information 1504) is increased or decreased in accordance with the time scale. Along with this, the length of the viewpoint element bar 1552 displayed within the timeline B region 1350 is also changed. Obviously, the date and time displayed at the time axis 1315 is also changed.

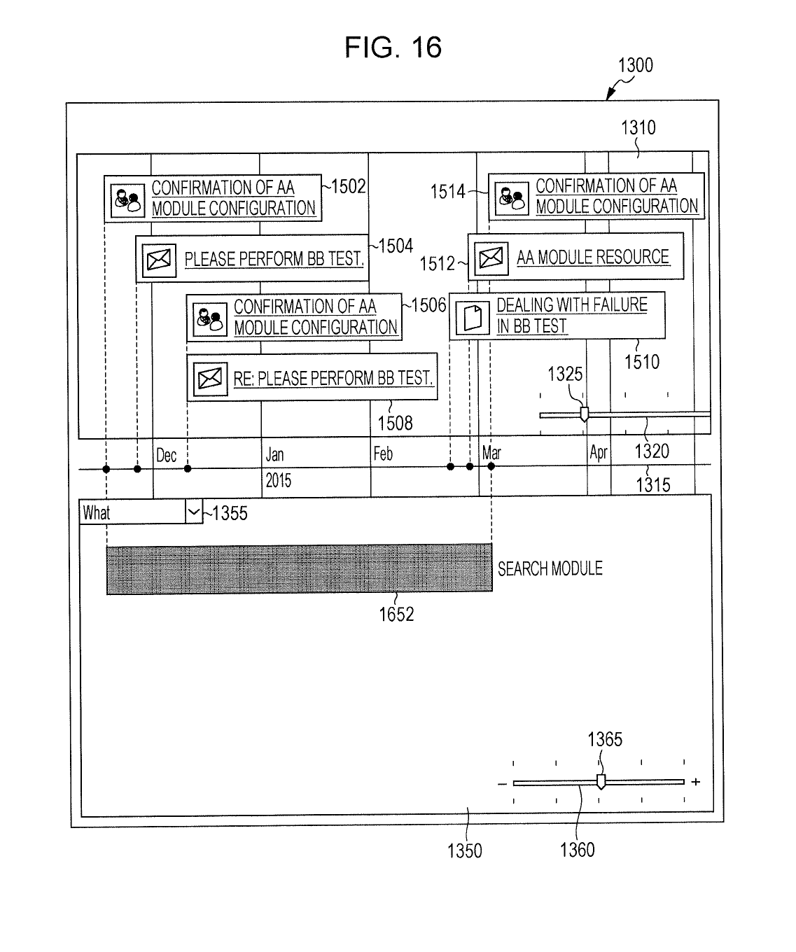

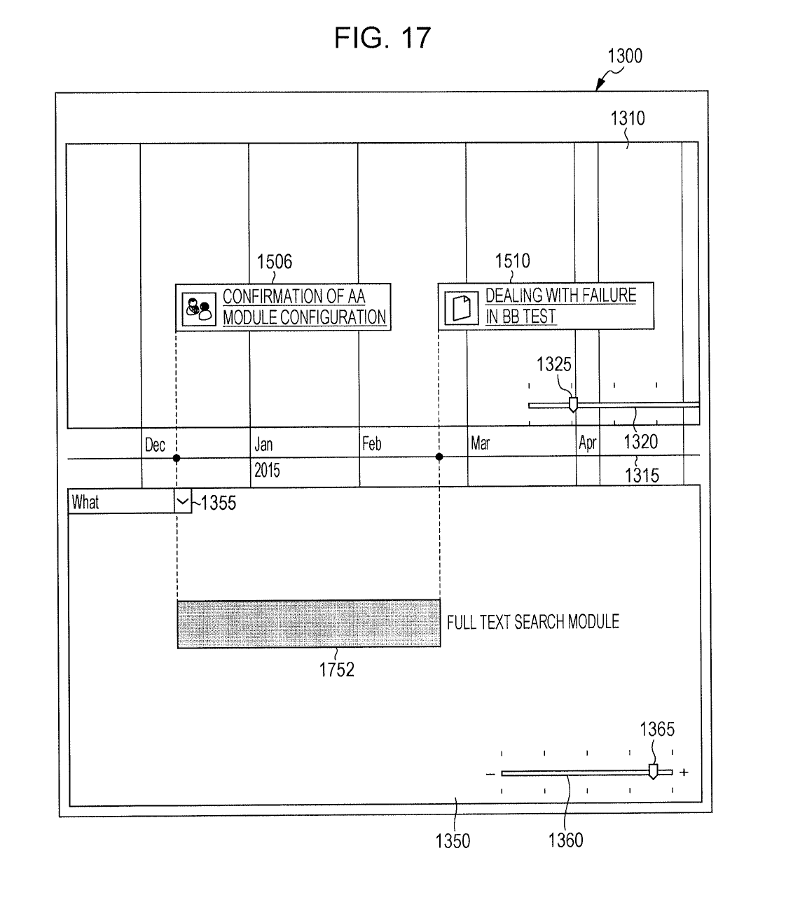

FIG. 16 illustrates a display example for the case where the knob 1365 of the slider bar B 1360 is lowered by one level. A viewpoint element bar 1652 indicates a “search module”. The event or other information 1502 to 1514 indicates association with the “search module”. In the example of FIG. 16, the viewpoint element bar 1652 indicating the search module 512, which is in the layer immediately below the natural language search system 510, is displayed in the timeline B region 1350, and all the event information which is associated with the search module 512 (the event or other information 1502 to 1514) is displayed in the timeline A region 1310. In this example, information in an upper layer is not displayed. However, the information in the upper layer may be displayed.

FIG. 17 illustrates a display example for the case where the knob 1365 is further lowered by one level relative to FIG. 16. A viewpoint element bar 1752 indicates a “full text search module”. The event or other information 1506 and the event or other information 1510 indicate association with the “full text search module”. In the example of FIG. 17, the viewpoint element bar 1752 indicating the full text search module 520 and the attribute search module 522, which are in the layer immediately below the search module 512, is displayed in the timeline B region 1350, and all the event information which is associated with the full text search module 520 (the event or other information 1506 and the event or other information 1510) is displayed in the timeline A region 1310. However, in this example, no event information which is associated with the attribute search module 522 exists, and therefore a bar indicating the attribute search module 522 is not displayed.

By changing the layer to be displayed using the slider bar B 1360 within the timeline B region 1350, the number of items of event information displayed in the timeline A region 1310 may be adjusted. Therefore, only a layer that a user wants to browse may be displayed. Even in the case where a large amount of event information exists, review of past activities may be easily achieved.

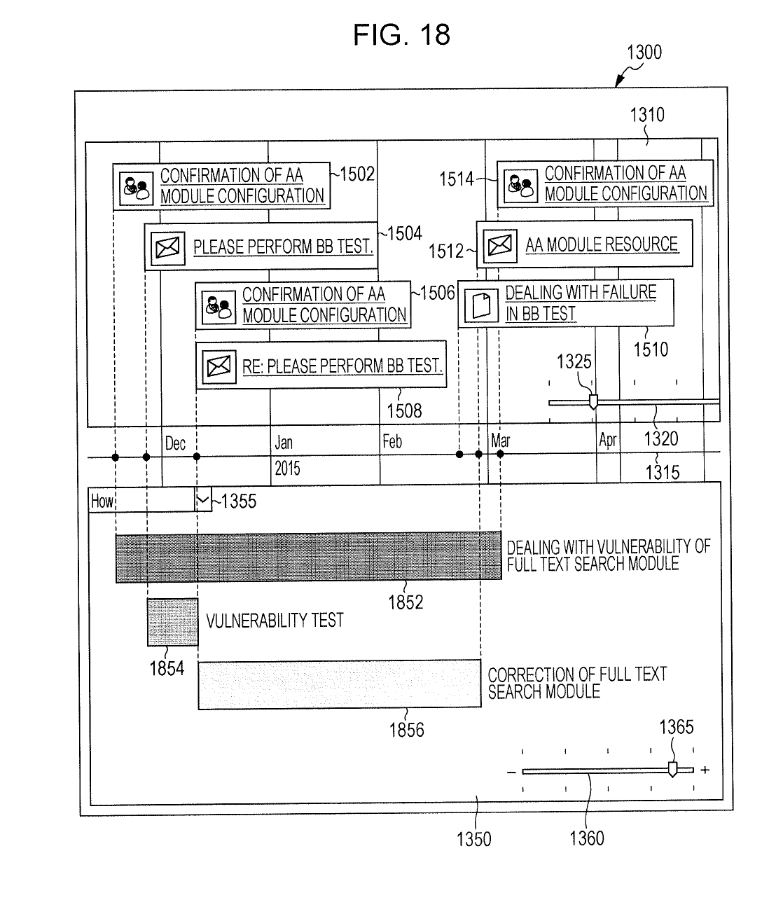

Next, an operation example for the case where a user selects a viewpoint “How” (“How” with the viewpoint selection pulldown menu 1355) will be described with reference to an example illustrated in FIG. 18.

In this example, when “How” is selected, a “task” is displayed for each layer. A task mentioned in this example indicates a collection of a series of events which adds a change to an “object” or a “thing”. Furthermore, the data illustrated in the examples of FIGS. 8 and 9 is used as target data. In this example, each piece of all the event information belongs to a corresponding one of tasks. However, event information may belong to no task. Furthermore, a single piece of event information may belong to multiple tasks.

FIG. 18 illustrates a display example for the case where a viewpoint “How” is selected. A viewpoint element bar 1852 indicates “dealing with vulnerability of full text search module”, a viewpoint element bar 1854 indicates a “vulnerability test”, and a viewpoint element bar 1856 indicates “correction of full text search module”. In the example of FIG. 18, all the tasks (the viewpoint element bar 1852, the viewpoint element bar 1854, and the viewpoint element bar 1856 indicating tasks within the task table 800) are displayed in the timeline B region 1350. In this example, there is no hierarchical relationship between tasks (tasks have a one-layer hierarchical structure), and therefore all the events which are associated with a task (the event or other information 1502 to 1514) are displayed in the timeline A region 1310.

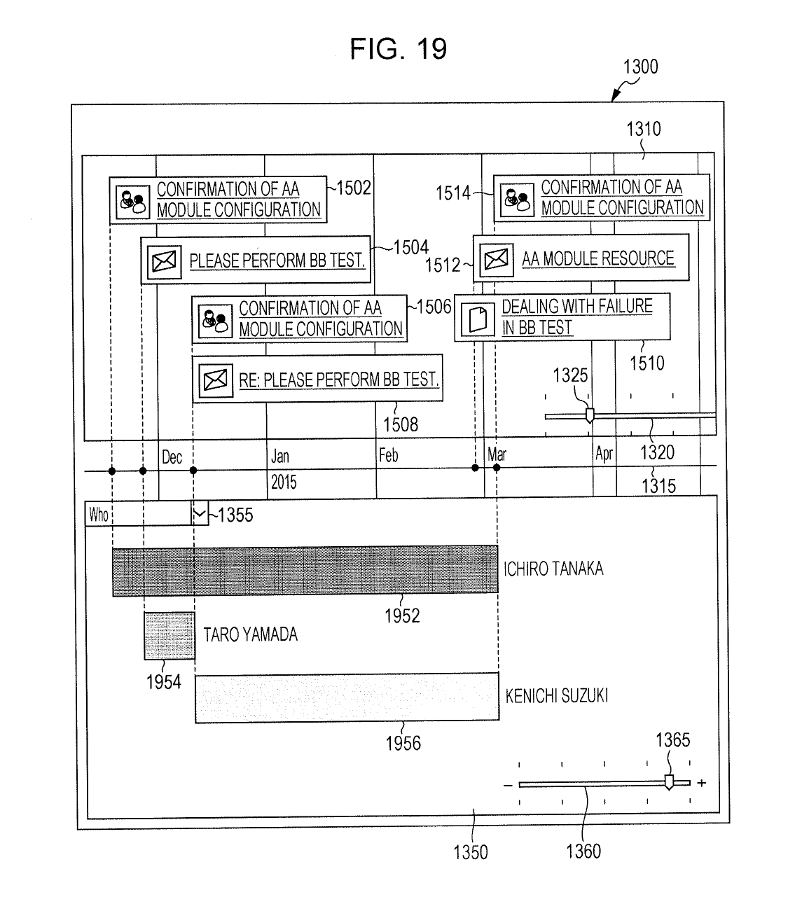

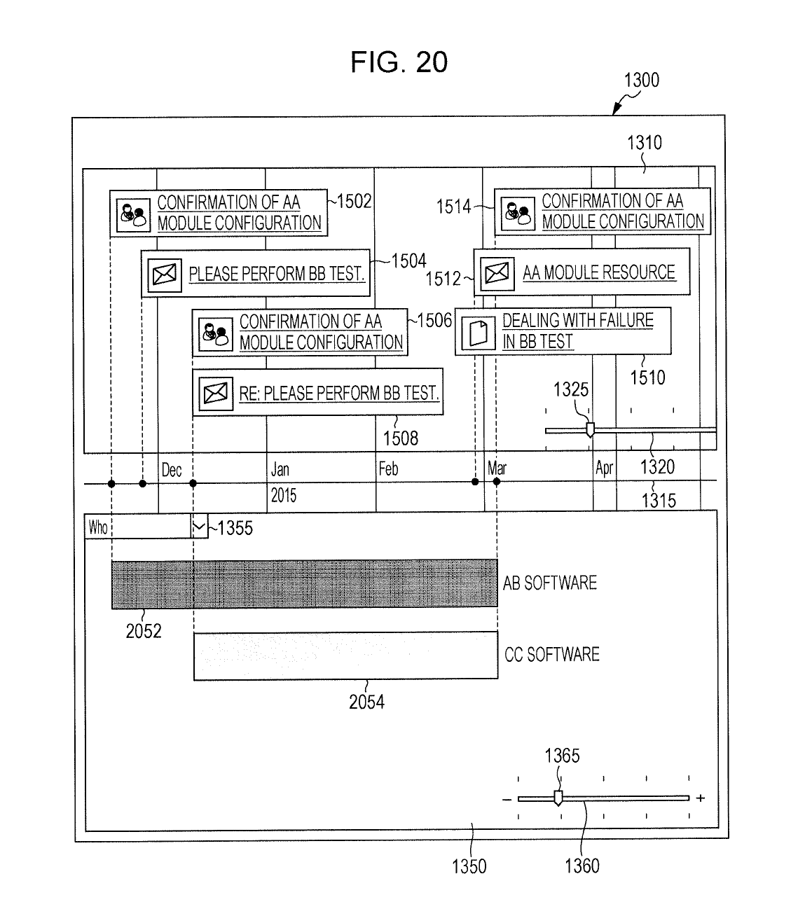

Next, an operation example for the case where a user selects a viewpoint “Who” (“Who” with the viewpoint selection pulldown menu 1355) will be described with reference to examples illustrated in FIGS. 19 and 20.

In this example, when “Who” is selected, a “person” and an “organization” are displayed for each layer. Furthermore, the data illustrated in the examples of FIGS. 11 and 12 is used as target data.

FIG. 19 illustrates a display example for the case where a viewpoint “Who” is selected. A viewpoint element bar 1952 indicates “Ichiro Tanaka”, a viewpoint element bar 1954 indicates “Taro Yamada”, and a viewpoint element bar 1956 indicates “Kenichi Suzuki”. In this example, an organization and a person have a hierarchical relationship. In the example of FIG. 19, the lowest layer (=the layer of a person) is displayed.

A display example for the case where the knob 1365 of the slider bar B 1360 at the lower right within the timeline B region 1350 is moved leftwards from the state illustrated in the example of FIG. 19 and an upper layer is thus selected will be illustrated in FIG. 20. A viewpoint element bar 2052 indicates “AB software”, and a viewpoint element bar 2054 indicates “CC software”. That is, the viewpoint element bar 2052 is obtained by combining the viewpoint element bar 1952 and the viewpoint element bar 1954, which are illustrated in the example of FIG. 19, and the viewpoint element bar 2054 corresponds to the viewpoint element bar 1956 illustrated in the example of FIG. 19.

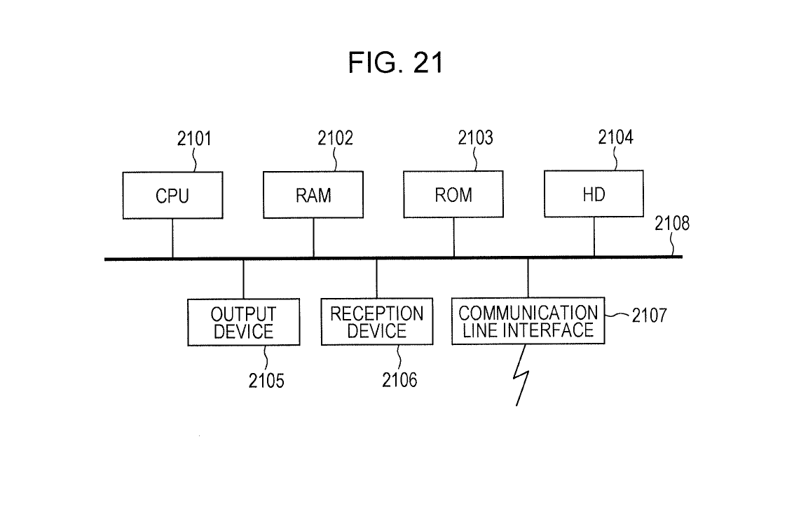

A hardware configuration of a computer which executes a program according to an exemplary embodiment is a general computer, as illustrated in FIG. 21, and is, specifically, a personal computer, a computer which may serve as a server, or the like. That is, as a specific example, a CPU 2101 is used as a processing unit (arithmetic unit), and a RAM 2102, a read only memory (ROM) 2103, and a hard disk (HD) 2104 are used as a storage device. As the HD 2104, for example, a hard disk or a solid state drive (SDD) may be used. The computer includes the CPU 2101 which executes programs such as the event information display module 105, the viewpoint information input module 110, the viewpoint information display module 115, the display period input module 120, the viewpoint granularity input module 125, and the display contents synchronization module 130, the RAM 2102 which stores the programs and data, the ROM 2103 which stores a program and the like for starting the computer, the HD 2104, which is an auxiliary storage device (may be a flash memory) having functions of the event-viewpoint information storing module 135, the event information storing module 140, the viewpoint information storing module 145, and the like, a reception device 2106 which receives data based on a user operation for a keyboard, a mouse, a touch panel, a microphone, or the like, an output device 2105 such as a cathode ray tube (CRT), a liquid crystal display, or a speaker, a communication line interface 2107 for allowing connection with a communication network such as a network interface card, and a bus 2108 which connects the above devices to allow data exchange. The computer above mentioned may be provided in plural and connected to one another by a network.

The foregoing exemplary embodiment that relates to a computer program is implemented by causing a system of the above hardware configuration to read the computer program, which is software, in cooperation of software and hardware resources.

The hardware configuration illustrated in FIG. 21 illustrates a configuration example. An exemplary embodiment is not limited to the configuration illustrated in FIG. 21 as long as a configuration which may execute modules explained in the exemplary embodiment is provided. For example, part or all of the modules may be configured as dedicated hardware (for example, an application specific integrated circuit (ASIC) or the like), part or all of the modules may be arranged in an external system in such a manner that they are connected via a communication line, or the system illustrated in FIG. 21 which is provided in plural may be connected via a communication line in such a manner that they operate in cooperation. Furthermore, in particular, part or all of the modules may be incorporated in a personal computer, a portable information communication device (including a mobile phone, a smart phone, a mobile device, and a wearable computer), an information electronic appliance, a robot, a copying machine, a facsimile machine, a scanner, a printer, or a multifunction device (an image processing device having two or more functions of a scanner, a printer, a copying machine, a facsimile machine, and the like).

The programs described above may be stored in a recording medium and provided or may be supplied through communication. In this case, for example, the program described above may be considered as an invention of “a computer-readable recording medium which records a program”.

“A computer-readable recording medium which records a program” represents a computer-readable recording medium which records a program to be used for installation, execution, and distribution of the program.

A recording medium is, for example, a digital versatile disc (DVD), including “a DVD-R, a DVD-RW, a DVD-RAM, etc.”, which are the standards set by a DVD forum, and “a DVD+R, a DVD+RW, etc.”, which are the standards set by a DVD+RW, a compact disc (CD), including a read-only memory (CD-ROM), a CD recordable (CD-R), a CD rewritable (CD-RW), etc., a Blu-ray™ ray Disc, a magneto-optical disk (MO), a flexible disk (FD), a magnetic tape, a hard disk, a ROM, an electrically erasable programmable read-only memory (EEPROM™), a flash memory, a RAM, a secure digital (SD) memory card, or the like.

The entire or part of the above-mentioned program may be recorded in the above recording medium, to be stored and distributed. Furthermore, the program may be transmitted through communication, for example, a wired network or a wireless communication network used for a local area network (LAN), a metropolitan area network (MAN), a wide area network (WAN), the Internet, an intranet, an extranet, or the like, or a transmission medium of a combination of the above networks. Alternatively, the program or a part of the program may be delivered by carrier waves.

The above-mentioned program may be the entire or part of another program or may be recorded in a recording medium along with a separate program. Further, the program may be divided into multiple recording media and recorded. The program may be recorded in any format, such as compression or encryption, as long as the program may be reproduced.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first presenting unit that presents first information in a chronological order in a first region;
a second presenting unit that presents hierarchized second information which is associated with the first information in a second region;
a receiving unit that receives specification of a layer of the second information; and
a controller that controls the second presenting unit such that the second information in the specified layer is presented in the second region, and controls the first presenting unit such that first information which is associated with the second information is presented in the first region.

2. The information processing apparatus according to claim 1, further comprising:
a second receiving unit that receives a target period of the first information to be presented in the first region,
wherein the controller controls the first presenting unit such that the first information within the target period is presented in the first region in accordance with the target period, and controls the second presenting unit such that second information which is associated with the first information is presented in the second region in accordance with the first information within the first region.

3. The information processing apparatus according to claim 1, wherein the controller performs control such that second information which is in a layer upper than the specified layer is presented in the second region.

4. The information processing apparatus according to claim 2, wherein the controller performs control such that second information which is in a layer upper than the specified layer is presented in the second region.

5. The information processing apparatus according to claim 1,
wherein in a case where the second information in the specified layer is not associated with the first information presented in the first region, the controller controls the second information not to be presented in the second region.

6. The information processing apparatus according to claim 2, wherein in a case where the second information in the specified layer is not associated with the first information presented in the first region, the controller controls the second information not to be presented in the second region.

7. The information processing apparatus according to claim 3, wherein in a case where the second information in the specified layer is not associated with the first information presented in the first region, the controller controls the second information not to be presented in the second region.

8. The information processing apparatus according to claim 1, further comprising:
a third receiving unit that receives a viewpoint in hierarchization of the second information,
wherein the controller controls the second presenting unit such that second information in the specified layer which is associated with the viewpoint is presented in the second region, and controls the first presenting unit such that first information which is associated with the second information is presented in the first region.

9. The information processing apparatus according to claim 2, further comprising:
a third receiving unit that receives a viewpoint in hierarchization of the second information,
wherein the controller controls the second presenting unit such that second information in the specified layer which is associated with the viewpoint is presented in the second region, and controls the first presenting unit such that first information which is associated with the second information is presented in the first region.

10. The information processing apparatus according to claim 3, further comprising:
a third receiving unit that receives a viewpoint in hierarchization of the second information,
wherein the controller controls the second presenting unit such that second information in the specified layer which is associated with the viewpoint is presented in the second region, and controls the first presenting unit such that first information which is associated with the second information is presented in the first region.

11. The information processing apparatus according to claim 4, further comprising:
a third receiving unit that receives a viewpoint in hierarchization of the second information,
wherein the controller controls the second presenting unit such that second information in the specified layer which is associated with the viewpoint is presented in the second region, and controls the first presenting unit such that first information which is associated with the second information is presented in the first region.

12. The information processing apparatus according to claim 5, further comprising:
a third receiving unit that receives a viewpoint in hierarchization of the second information,
wherein the controller controls the second presenting unit such that second information in the specified layer which is associated with the viewpoint is presented in the second region, and controls the first presenting unit such that first information which is associated with the second information is presented in the first region.

13. The information processing apparatus according to claim 6, further comprising:
a third receiving unit that receives a viewpoint in hierarchization of the second information,
wherein the controller controls the second presenting unit such that second information in the specified layer which is associated with the viewpoint is presented in the second region, and controls the first presenting unit such that first information which is associated with the second information is presented in the first region.

14. The information processing apparatus according to claim 7, further comprising:
a third receiving unit that receives a viewpoint in hierarchization of the second information,
wherein the controller controls the second presenting unit such that second information in the specified layer which is associated with the viewpoint is presented in the second region, and controls the first presenting unit such that first information which is associated with the second information is presented in the first region.

15. The information processing apparatus according to claim 8, further comprising:
a third receiving unit that receives a viewpoint in hierarchization of the second information,
wherein the controller controls the second presenting unit such that second information in the specified layer which is associated with the viewpoint is presented in the second region, and controls the first presenting unit such that first information which is associated with the second information is presented in the first region.

16. An information processing method comprising:
presenting first information in a chronological order in a first region;
presenting hierarchized second information which is associated with the first information in a second region;
receiving specification of a layer of the second information; and
controlling the second presenting unit such that the second information in the specified layer is presented in the second region, and controls the first presenting unit such that first information which is associated with the second information is presented in the first region.

17. A non-transitory computer readable medium storing a program causing a computer to execute a process for information, the process comprising:
presenting first information in a chronological order in a first region;
presenting hierarchized second information which is associated with the first information in a second region;
receiving specification of a layer of the second information; and
controlling the second presenting unit such that the second information in the specified layer is presented in the second region, and controls the first presenting unit such that first information which is associated with the second information is presented in the first region.
